(19) United States
(12) Patent Application Publication
(10) Pub. No.: US 2015/0121280 A1
(43) Pub. Date: Apr. 30, 2015

(54) Systems and Methods for Data Transfer with Graphic Interface

(71) Applicants: Matt Slatner, Richmond, VA (US); Mike Ogilvie, Richmond, VA (US)

(72) Inventors: Matt Slatner, Richmond, VA (US); Mike Ogilvie, Richmond, VA (US)

(21) Appl. No.: 14/527,441

(22) Filed: Oct. 29, 2014

Related U.S. Application Data
(60) Provisional application No. 61/896,864, filed on Oct. 29, 2013.

(51) Int. Cl. G06F 3/0484; G06F 17/30

(52) U.S. Cl. CPC G06F 3/0484; G06F 17/30864
USPC 715/772; 707/769

(57) ABSTRACT

The invention is directed to systems, graphical user interfaces (GUI), and methods of providing data managers with a data management solution that provides visibility of data streams and quality and determine if a data feed has adequate health. Methods may include receiving an data feed; determining applicable historical information; determining quality rules; determining associated metadata; and determining if the data feed has adequate health and if so, processing the data feed. Systems may include a data processing engine to process the data feed, an operations management node to create metadata for data feed, a quality and validation node to quantify quality characteristics of a data stream, a decision engine to determine if a data feed requires manual intervention and automatically determine, based at least in part upon metadata, processing paths to be utilized by the data processing engine; and a graphical user interface enabling users to control data feed decisions.

### RELATED APPLICATIONS

This application claims priority to U.S. Provisional Patent Application No. 61/896,864, filed on 29 Oct. 2013 entitled “Improved Data Transfer with Graphical Interface,” which is incorporated herein by reference in its entirety.

### BACKGROUND OF THE INVENTION

In general, the present invention is directed to systems and methods of moving data between a first location and a second location in an efficient and transparent manner while understanding the data flow, quality, and management. Specifically, the present invention is directed to a data integration, quality, and management solution that does not require custom coding and provides data managers with inbound and outbound data sets consistently and accurately.

In general, many companies are required to store, query, process, transfer, and otherwise utilize large amounts of data. For example, data may comprise information regarding medical records, automated teller machine (ATM) transactions, inventory, etc. Data managers responsible for managing and processing such data often struggle to load and transfer data (both inbound and outbound) consistently and accurately.

Data managers often struggle with capacity planning, financial planning, managing data growth, and developing and implementing strategies to control costs. For example, with regard to capacity planning, it is often unclear (i) how much data is processed; (ii) how large are the files that are processed; (iii) how can inventory be effectively managed; and (iv) how long with data processing require. With regard to financial planning, it is often unclear (i) how much it may cost to establish and set up a new data feed; and (ii) how many people will a new data feed require for support once in production?

According to the Data Management Association (DAMA), up to twenty-five percent (25%) of an organization's operating expense is wasted due to data quality issues. Enterprise experts have noted this loss can rise as high as forty-five percent (45%). Analysts often spend the large majority of their time and effort (up to eighty percent (80%)) trying to obtain and introduce the right data before performing any analysis (“data triage”). This leaves such analysts with a reduced amount of time to perform the task that was actually requested and/or required.

Data triage, as noted above, may comprise solving issues including but not limited to: (i) is there data missing, incomplete, or late; (ii) is the data quality adequate to perform any requested and/or required analysis or processing; (iii) is the data in the proper format; and (iv) how much data should have been processed, and how much data was actually processed.

Accordingly, systems and methods for providing data managers with a data integration, quality, and management solution that provides visibility of data streams, quality, and management is desired.

Systems and methods that provide data managers with a data integration, quality, and management solution that provides validation of the health or quality of data before it is used in analytics is desired.

Systems and methods that provide data managers with a data integration, quality, and management solution that is customizable, integrates within ETL/Operations (extract, transfer, load processes), but does not require on custom code development is desirable.

### SUMMARY OF THE INVENTION

Some aspects in accordance with some embodiments of the present invention may include a system for providing data managers with a data integration, quality, and management solution that provides visibility of data streams and data quality, provides ability to manage data processing tasks, and determines if a data feed has adequate health to be delivered to an end user or location, the system comprising: a data processing engine, configured to process a data feed using parallel processing to perform a task, the task selected from the group consisting of: decrypt, stage, transform, validate, filter, encrypt, and archive data feed; an operations management node in communication with the data processing engine, configured to create metadata for data feeds, the metadata comprising information associated with one or more of: schedule, owner, source information, transformations, quality rules, notifications, reporting, and destination information; a quality and validation node in communication with the operations management node, configure to quantify quality characteristics of a data stream by utilizing predefined data quality measures and applying historic metadata and historical trends against data feed information; a decision engine, configured to automatically determine if a data feed requires manual intervention and automatically determine, based at least in part upon metadata, processing paths to be utilized by the data processing engine; and a graphical user interface that displays on a computer screen data regarding the processing of the data feed, enabling users to control data feed decisions, as alerted by the decision engine, and displaying including real-time operational data, historical data, and metadata associated with the data feed and the data processing task.

Other aspects in accordance with some embodiments of the present invention may include: a method of providing visibility of data feed and data quality and determining if a data feed has adequate health to be delivered to an end user or location, the method comprising: receiving an inbound data feed; querying a data store to determine if any historical information related to the inbound data feed exists or is applicable; determining quality rules applicable to the inbound data feed; determining metadata associated with the data feed; based upon the historical information, quality rules, and metadata, determining if the data feed has adequate health; and if it is determined that the data feed has adequate health, processing the data feed; or if it is determined that the data feed does not have adequate health, stopping the import of the data feed and sending an electronic alert to a user.

Other aspects in accordance with some embodiments of the present invention may include: a graphical user interface displayed on a computer screen for receiving user selection of data processing options, and for presenting to the user various data and analytics regarding data processing, the user interface comprising: a plurality of graphical interface pages arranged in a hierarchical format, wherein a dashboard presenting a user with information regarding current processing tasks is a parent page; and wherein the dashboard comprises links to child pages, the child pages presenting information related to set up of inbound data feeds, destination of inbound data feeds, data feed details, notification or alert settings, status of service level agreement (SLA) conditions or expectations, performance analytics, and reports on data processing tasks.

Other aspects in accordance with some embodiments of the present invention may include: a system for providing visibility of data streams and data quality, an ability to manage data processing tasks, and determining if a data feed has adequate health to be delivered to an end user or location, the system comprising: a central processor in selective communication with a data processing engine, an operations management module, a quality and validation module, a graphical user interface, and a decision engine, the central processor receiving raw data from the data processing engine and distributing the raw data to, and receiving feed instance data from, the operations management module and quality and validation module; the data processing engine, configured to receive an inbound data feed from a source and to electronically transmit an outbound data feed to a destination; the operations management module in selective communication with a data store comprising feed metadata and historical operations metadata; the quality and validation module comprising one or more data stores comprising historical feed content metadata and feed level thresholds metadata; the graphical user interface, being displayed on a computer screen for receiving user selection of data processing options, and for presenting to the user various data and analytics regarding data processing, comprising a plurality of graphical interface pages arranged in a hierarchical format; and a decision engine, configured to determine if the data has a sufficient health to be provided to the outbound destination, and to determine if the outbound data meets any applicable service level agreement requirements.

These and other aspects will become apparent from the following description of the invention taken in conjunction with the following drawings, although variations and modifications may be effected without departing from the scope of the novel concepts of the invention.

### BRIEF DESCRIPTION OF THE FIGURES

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates a general data flow, in accordance with some embodiments of the present invention.

FIG. 2 illustrates an exemplary data flow, in accordance with some embodiments of the present invention.

FIG. 3 illustrates an exemplary schematic of a system for processing data flows, in accordance with some embodiments of the present invention.

FIG. 4 depicts an exemplary method of file transfer in a data processing engine, in accordance with some embodiments of the present invention.

FIG. 5 illustrates an exemplary processing of queueing data, in accordance with some embodiments of the present invention.

FIG. 6 illustrates an exemplary process of data staging, in accordance with some embodiments of the present invention.

FIG. 7 illustrates an exemplary process of determining data quality, in accordance with some embodiments of the present invention.

FIG. 8 illustrates an exemplary system for determining optimal or near optimal processing paths, in accordance with some embodiments of the present invention.

FIG. 9 illustrates an exemplary process of determining historical trending in a data stream, in accordance with some embodiments of the present invention.

FIG. 10 illustrates exemplary data processing in parallel, in accordance with some embodiments of the present invention.

FIG. 11 illustrates an exemplary data flow, in accordance with some embodiments of the present invention.

FIG. 12 illustrates an exemplary screen capture from a graphical user interface that presents information regarding data transfer or processing, in accordance with some embodiments of the present invention.

FIG. 13 illustrates an exemplary screen capture from a graphical user interface that presents information regarding data transfer or processing, in accordance with some embodiments of the present invention.

FIG. 14 illustrates an exemplary screen capture from a graphical user interface that presents information regarding data transfer or processing, in accordance with some embodiments of the present invention.

FIG. 15 illustrates an exemplary screen capture from a graphical user interface that presents information regarding data transfer or processing, in accordance with some embodiments of the present invention.

FIG. 16 illustrates an exemplary screen capture from a graphical user interface that presents information regarding data transfer or processing, in accordance with some embodiments of the present invention.

FIG. 17 illustrates an exemplary screen capture from a graphical user interface that presents information regarding data transfer or processing, in accordance with some embodiments of the present invention.

FIG. 18 illustrates an exemplary notification or alert, in accordance with some embodiments of the present invention.

FIG. 19 illustrates an exemplary screen capture from a graphical user interface that presents information regarding data transfer or processing, in accordance with some embodiments of the present invention.

FIG. 20 illustrates an exemplary screen capture from a graphical user interface that presents information regarding data transfer or processing, in accordance with some embodiments of the present invention.

FIG. 21 illustrates an exemplary screen capture from a graphical user interface that presents information regarding data transfer or processing, in accordance with some embodiments of the present invention.

FIG. 22 illustrates an exemplary screen capture from a graphical user interface that presents information regarding data transfer or processing, in accordance with some embodiments of the present invention.

FIG. 23 illustrates an exemplary screen capture from a graphical user interface that presents information regarding data transfer or processing, in accordance with some embodiments of the present invention.

FIG. 24 illustrates an exemplary screen capture from a graphical user interface that presents information regarding data transfer or processing, in accordance with some embodiments of the present invention.

FIG. 25 illustrates an exemplary screen capture from a graphical user interface that presents information regarding data transfer or processing, in accordance with some embodiments of the present invention.

FIG. 26 illustrates an exemplary screen capture from a graphical user interface that presents information regarding data transfer or processing, in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

In general, the present invention is directed to systems and methods of moving data between a first location and a second location in an efficient and transparent manner while understanding the data flow, quality, and management. Specifically, the present invention is directed to a data integration, quality, and management solution that does not require custom coding and provides data managers with inbound and outbound data sets consistently and accurately.

For example, systems and methods in accordance with some embodiments of the present invention may validate data sets in order to keep data stores clean by combining related information (metadata) regarding inbound and outbound data sets. This may mitigate potential risk associated with missing or incomplete data sets. For example, inaccurate data may lead to financial risk due to inaccurate throughput. Systems and methods in accordance with some embodiments of the present invention may leverage feed (or inbound) metadata and related movement information to access the quality of timeliness and content. This information may be used, at least in part, to determine whether a data set should be integrated or held for further analysis by a data operator or analyst.

Related movement information, as used above, may be derived from several sources. For example, historical information regarding the health of the data within the feed by may be utilized. Such information may be derived from overall feed size and information specifically within each data element in the data set. For example, percentage of population of values, percentage of unique values found within an element, and/or percentage of unique values matched to standard value sets. Alternatively, such information may be derived from end-user specified values.

Similarly, related movement information may be derived from information such as historical information regarding a receipt status of data sets compared to expected receipt status, or to end-user specified values. In addition, related movement information may be derived from processing performance data compared to expected performance (based on historical information), or to end-user specified values.

Systems and methods in accordance with some embodiments of the present invention may allow for the configuration of each feed definition, curate related information derived and decided on a data set by data set basis, and report such information through a graphical user interface.

Before delving into the specific processes and system components of the present invention, in order to properly orient a reader some features of the present invention will first be discussed. Such features—which address certain specific technical problems in the prior art—will provide a framework from which to better understand the latter specific recitations.

As noted above, data managers are often responsible for moving large amounts of data, or for handling and processing various inbound and outbound data streams. However, data managers lack systems and methods that provide—as the present invention so provides—an overview of the data flows, including a real-time view, access to historical data loads, end time predictions (for certain tasks), user alerts, and data quality determination, while also being customizable to a customer's environment, integrating with ETL data stores and processes, and can be run quickly (for example, through parallel processing), and used as a migration tool.

Systems and methods in accordance with some embodiments of the present invention may provide numerous technical advantages and/or features, including but not limited to: (i) providing end-to-end automation of data feed processes between systems; (ii) provide full integration with the data feed process to enable the feed to be cancelled, paused, or the priority of such feed to be changed; (iii) provide end-to-end reporting of every step in the data movement process; and/or (iv) provide varying levels of authority or control for users with varying levels of access.

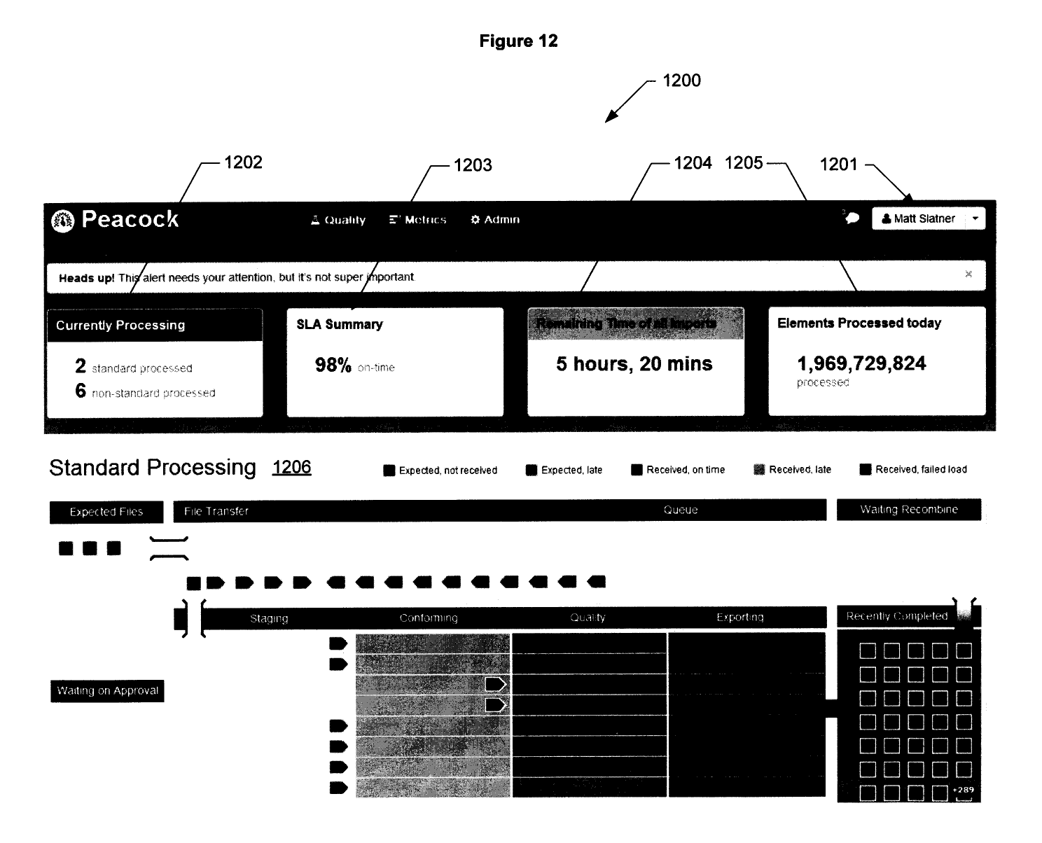

Moreover, as will be discussed in detail below (and with reference to FIGS. 12-27), systems and methods in accordance with some embodiments of the present invention may also provide an intuitive graphical user interface, which may provide real-time information regarding (i) what data is expected, and when it is expected; (ii) what data is currently loading and when loading is expected to be complete; (iii) what stage a data load is currently in; (iv) what specific data has been loaded; (v) illustrate to the user parallel data import paths, and which are busy or available; (vi) data loads that are waiting for approval to start; and/or (vii) paused data loads and data loads that are otherwise waiting for approval to continue.

Graphical user interfaces in accordance with some embodiments of the present invention may also illustrate for a user: (i) how many records per hour the system is capable of processing (which may be broken down to the feed level); (ii) real-time view of the state of all imports currently processing, waiting to process, and processed, and the status of the overall system; and/or (iii) the ability for a user to drill down to the specifics of each individual data import, data feed, source, and destination.

Moreover, the present invention may provide high speed processing. In accordance with some embodiments of the present invention, systems and methods may provide the ability to (i) process all import files against a series of parallel processing paths; (ii) control and balance processing loads across processing paths; and/or (iii) split import files into multiple parts where appropriate for multi-threaded execution across parallel processors.

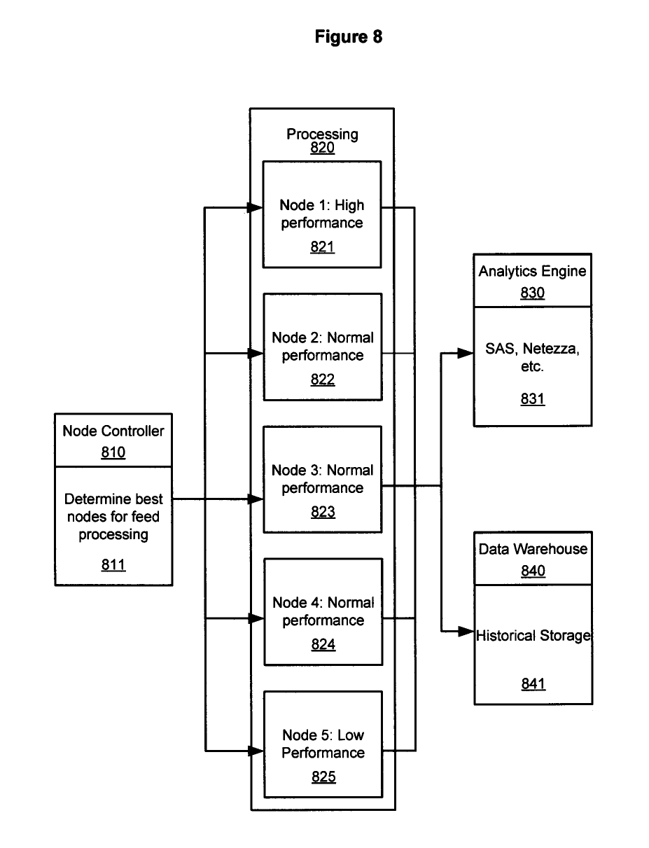

As will be discussed with regard to FIG. 8, in accordance with some embodiments of the present invention a performance optimizer module or node may also be utilized in order to determine an optimal or near-optimal server configuration for a processing path, and may report on expected throughput before installation.

Moreover, systems and methods in accordance with some embodiments of the present invention may provide certain file management characteristics, including but not limited to: (i) automated incoming file notifications; (ii) managing the sending of data; (iii) a file inventory system that provides what is expected to be in the system, and when it is expected; and/or (iv) automatic PGP decryption of inbound files and encryption of outbound files.

Similarly, systems and methods in accordance with some embodiments of the present invention may provide certain data archiving characteristics, including but not limited to: (i) specifying archival methods separately for each data feed (such as but not limited to, file saving, encryption, no storage, etc.); (ii) maintaining a store of all inbound and outbound data files; (iii) compressing data files after a specified amount of time has elapsed to save storage space; and/or (iv) optional encryption of archived files for security.

Also, systems and methods in accordance with some embodiments of the present invention may provide certain data mapping characteristics, including but not limited to: (i) providing a repository for all source and destination file formats and data elements; (ii) maintaining transformation logic; and/or (iii) providing data look-ups (such as transforming data based on an existing table, list, file, etc.).

Systems and methods in accordance with some embodiments of the present invention may also provide certain data quality characteristics, including but not limited to: (i) validating data quality trends against specified thresholds; (ii) providing automated Go/No Go processing based on previous trends and predefined thresholds; (iii) allowing data review by analysts in both raw file format and transferred format if the Go/No Go process pauses job due to concerns regarding data quality; (iv) validating inbound data against control files (if made available by the source); and/or (v) viewing data quality results for a specific data feed.

Systems and methods in accordance with some embodiments of the present invention may provide certain characteristics regarding a split load, including but not limited to: (i) taking a single input file and splitting it into multiple output files (for example, for pre-normalizing data for insertion into a destination location); and/or (ii) taking multiple input files and processing data in to a single output file.

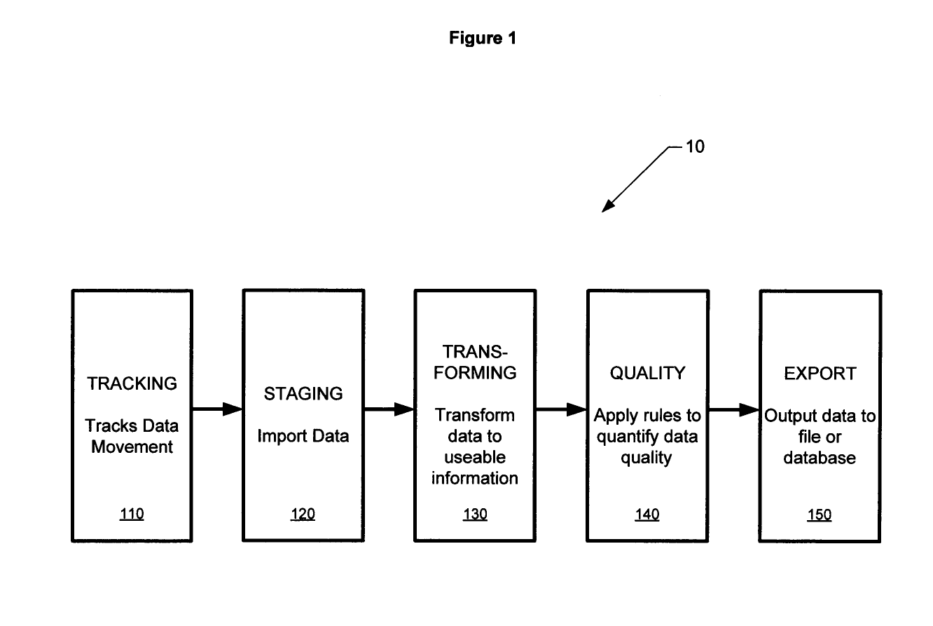

With reference to FIGS. 1-27, systems and methods in accordance with some embodiments of the present invention will now be discussed in greater detail. With reference to FIG. 1, a general data flow 10 is set forth. Systems and methods of the present invention may process data through a variety of nodes, comprising: a tracking node 110 that may track data movement; a staging node 120 that may import data into the system; a transforming node 130 that may transform data into useable information; a quality node 140 that may apply rules to quantify data quality; and/or an exporting node 150 that may output data to a file, database, or other data store.

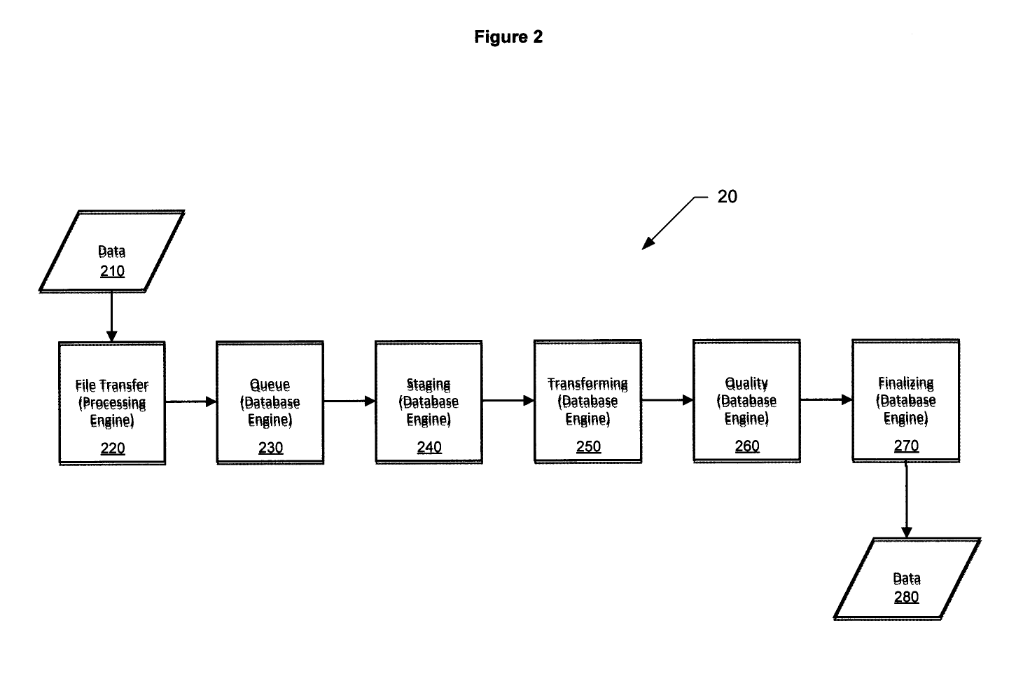

With reference to FIG. 2, the data flow may be set forth alternative as process 20. In process 20, inbound data 210 is input into the system at file transfer (or processing engine) node 220. The inbound data 210 may then enter the queue at 230 (which may, for example, be part of the database engine), and then proceed to staging at 240. At 250 the data may enter the transforming node, and the quality may be assessed or otherwise calculated or determined at 260. The database engine may then finalize the data at 270, and output outbound data at 280.

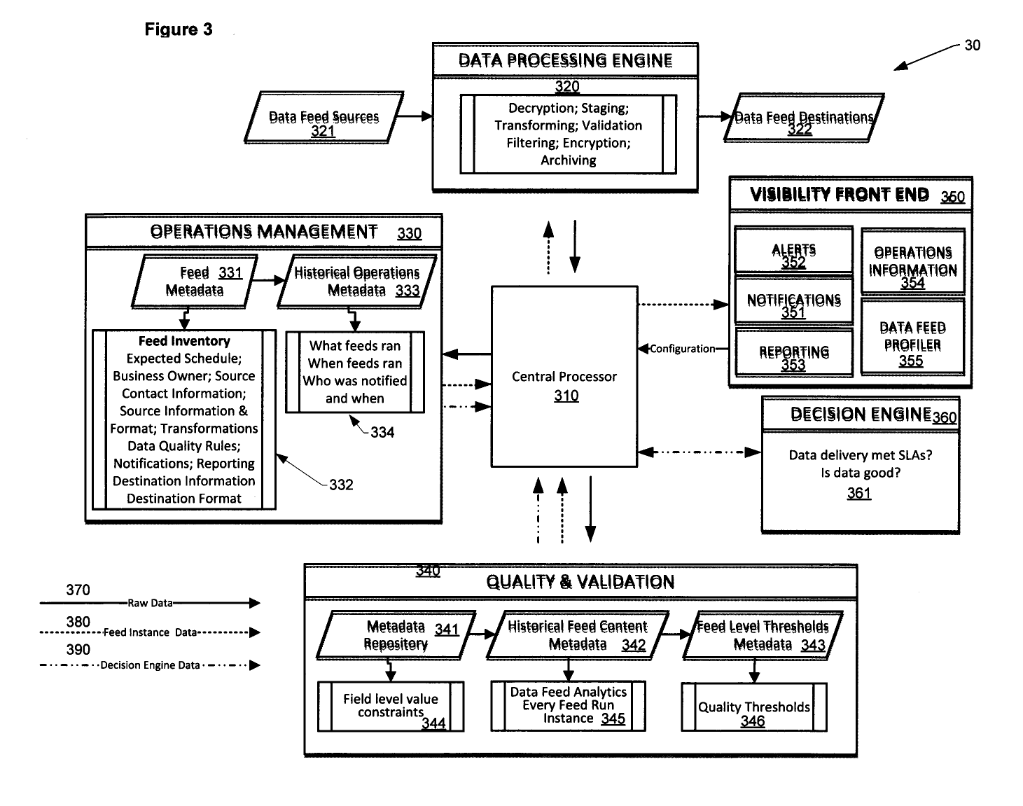

With reference to FIG. 3, a system 30 in accordance with some embodiments of the present invention may be graphically presented. System 30 may comprise a central processor 310 that may be in selective communication with various nodes. The various nodes may comprise (but are not limited to) a data processing engine 320, an operations management node 330, a quality and validation node 340, a visibility front end (e.g., a graphical user interface) 350, and a decision engine 360.

Note that with continued reference to FIG. 3, the schematic sets forth the type of data communicated between the nodes. Raw data 370, feed instance data 380, and/or decision engine data 390 may be communicated.

The central processor 310 may receive raw data from the data processing engine 320 and communicate the raw data to the operations management node 330 and the quality and validation node 340. The central processor 310 may also receive information regarding the configuration of the raw data from the visibility front end 350. The central processor may receive feed instance data from the operations management node 330 and the quality and validation node 340, and may communication such feed instance data to the data processing engine 320 and the visibility front end 350. The central processor 310 may also communicate decision engine data from and to decision engine 360, and may receive data for the decision engine 360 from the operations management node 330 and the quality and validation node 340.

The data processing engine 320 may receive one or more data streams from data feed sources 321, and may provide processed data to data feed destinations 322. Data processing engine may perform various processing tasks on the data feed, including but not limited to decryption, staging, transforming, validation, filtering, encryption, and/or archiving. Several of these tasks will be discussed in detail below.

Data processing engine 320 may provide raw data 370 to the central processor 310 for distribution to the operations management node 330 and the quality and validation node 340. Data processing engine 320 may also receive feed instance data 380 that may be used in any of the various processing tasks performed.

Operations and management node 330 may generally comprise data stores comprising feed metadata 331 and/or historical operations metadata 333, if available. Feed metadata 331 may be used to process several determinations, including but not limited to determining feed inventory, expected schedule of processing tasks, data owner and contact information, source information and/or format, transformations, data quality rules, notifications, reporting, destination information, and/or destination format. Historical operations metadata 333 may be used to determine, at least in part, tasks such as what feeds ran, when feeds ran, and/or who was historically notified and when regarding feeds.

Operations and management node 330 may receive raw data from the central processor 310, and may provide feed instance data and decision engine data back to central processor 310.

Quality and validation node 340 may generally comprise one or more data stores, comprising: a metadata repository 341, a historical feed content metadata 342, and/or a feed level thresholds metadata 343. Note that the historical feed content and feed level thresholds may alternatively be part of the metadata repository 341. The metadata repository 341 may be used to determine field level constraints 344. Historical feed content metadata may be utilized to determine, at least in part, data feed analytics on every feed run instance, including but not limited to file size, record counts, percentage of populations, distinct field level values, minimum/maximum/and/or average field level values, etc. Feed level thresholds metadata 343 may be utilized to determine, at least in part, quality thresholds. For example, such information may be utilized to determine what values should be for items such as file size, record counts, percentage of population, distinct field level values, minimum/maximum/and/or average field level values, etc. Such thresholds based on historical metadata may be utilized by the decision engine to determine if the data feeds are sufficiently accurate or healthy for use or processing.

The visibility front end node 350 may feed instance data from the central processor 310 and may transmit configuration information regarding raw data to the central processor 310 for compilation with raw data receive from the data processing engine 320 and distribution to the operations management node 330 and the quality and validation node 340.

The visibility front end node 350 may generally comprise a graphical user interface with which a user may control various aspects of the system. For example, the visibility front end node 350 may permit user to establish notifications 351 regarding certain data sets, thresholds, etc., so that a user may remain informed during each aspect of data processing (if so desired). The visibility front end 350 may also provide a user with alerts 351 regarding the status of data processing, reporting elements 353, and operations information 354, which may provide specific information about the operations being performed on the data feeds, including but not limited to how many records per hour the system is capable of processing (which may be broken down to the feed level), real-time view of the state of all imports currently processing, waiting to process, and processed, and/or the status of the overall system. Data feed profiler 355 may enable a user to drill down to the specifics of each individual data import, data feed, source, and destination.

Decision engine 360 may communicate decision engine data with the central processor. Decision engine 360 may determine if the data delivery meets any applicable service level agreement (SLA), and if the data is “good”—that is, sufficiently accurate and/or healthy.

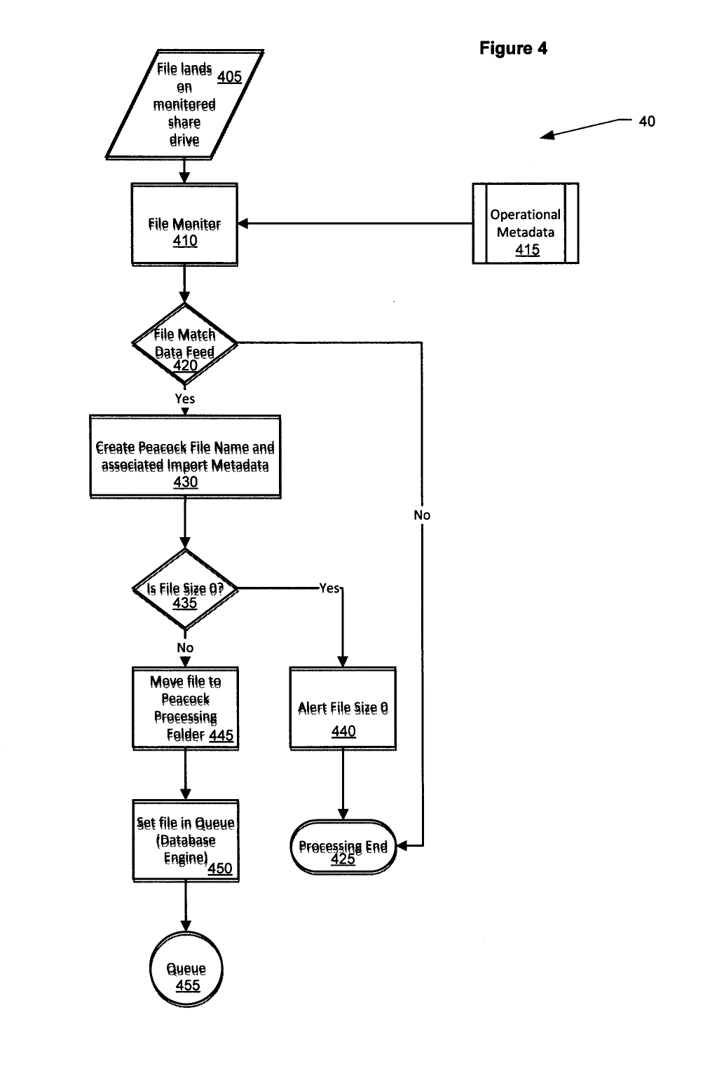

With reference to FIG. 4, an exemplary method 40 of file transfer in a data processing engine, in accordance with some embodiments of the present invention, will now be discussed. At 405 a file may be received on a monitored shared drive, and at 410 the file may be monitored. At 415 operational metadata may be utilized in monitoring the file. At 420 it may be determined if the file matches the data feed, and if not, the processing may terminate at 425. If the file does match the data feed, then the process may continue to 430 where a file name may be created and associated with imported relevant metadata. At 435, it may be determined if the file size is greater than zero (e.g, a faulty file), and if the file size is zero send an alert to a user at 440, and terminate the process at 425. If the file size is greater than zero, them the file is moved to the processing folder at 445, and set into the queue at 450, and queued up for processing at 455.

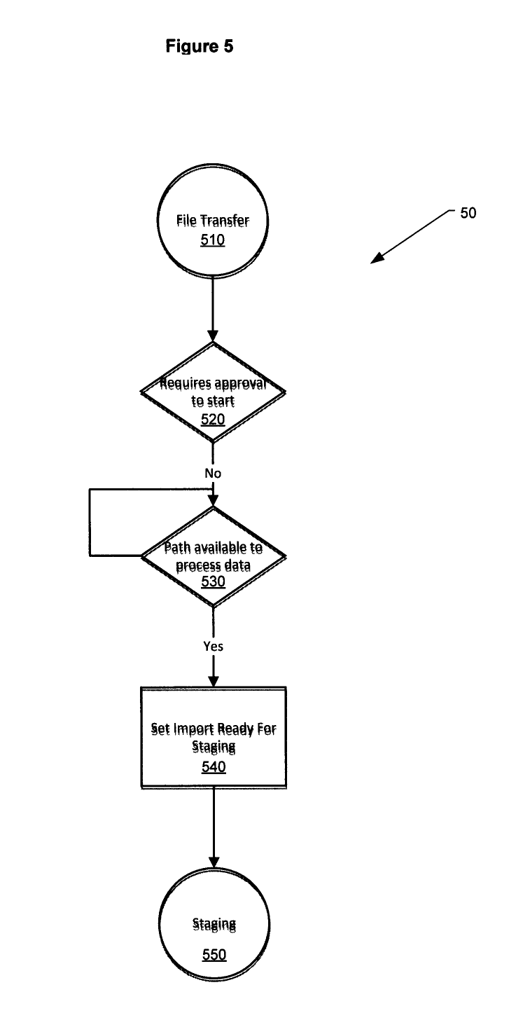

With reference to FIG. 5, an exemplary process of data queue, in accordance with some embodiments of the present invention, will now be discussed. At 510 the file transfer may be received, and at 520 it may be determined if any approvals are required to start processing the data. If no approvals are required, then an available path to process the data may be determined at 530. If a path is not available, the process may cycle through step 530 until a path is determined. Once a path to process the data is determined, the system sets import ready for staging at 540, and the process moves to staging at 550.

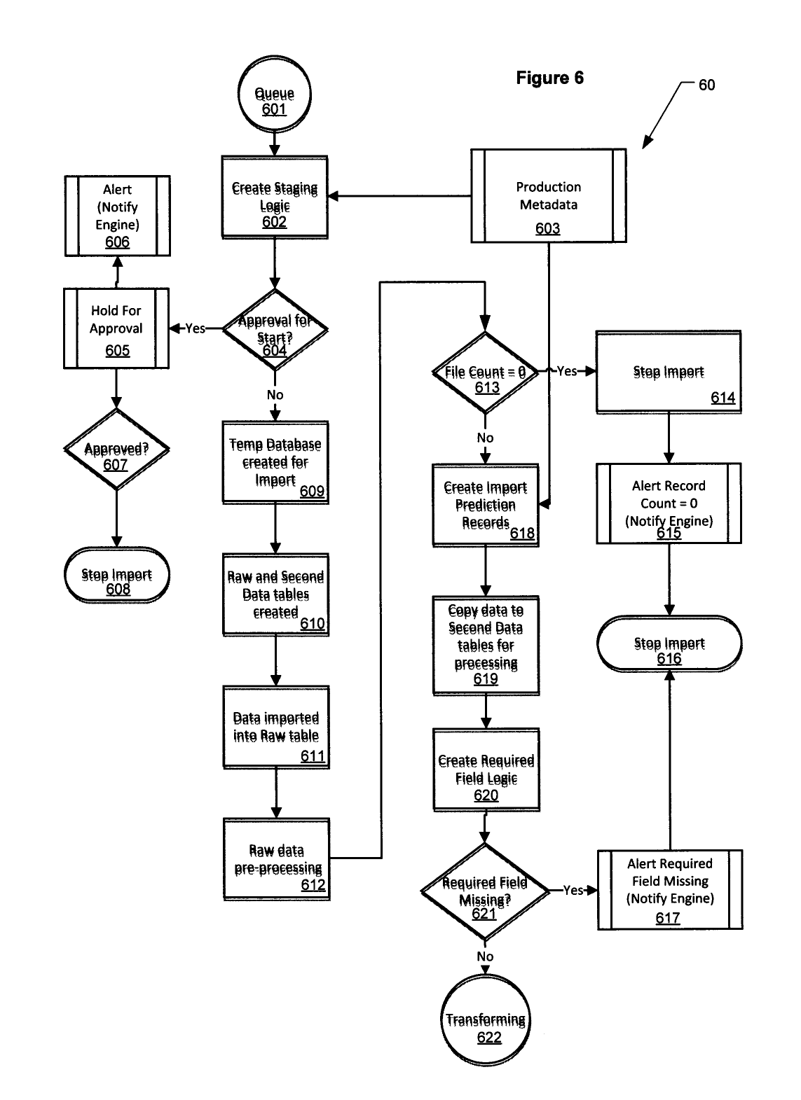

With reference to FIG. 6, an exemplary process of data staging, in accordance with some embodiments of the present invention will now be discussed. At 601 the data may be received from the queue (as set forth and discussed with regard to FIG. 5 above). At 602 staging logic may be created, which may utilize as an input associated production metadata. At 602 it may be determined if an approval is required to start the staging, and if so, the process may be held at 605 for approval (which may be, for example, be determined by the decision engine) and alert sent at 606 to a relevant user. If an approval is received at 607 then the import may be stopped at 608.

At 609 a temporary database may be created for the import, and at 610 raw data tables and second data tables may be created. At 611 data may be imported into the raw table, and the raw data may be pre-processed at 612. At 613 it may be determined if the file count is equal to zero, and if so, the import may be ceased at 614, an alert may be sent to a user at 615, and the import may be fully stopped at 616. If the file count is not equal to zero, then import prediction records may be created at 618, based at least in part on production metadata 603. At this point, data may be copied to the second data tables for processing at 619, and required field logic may be created at 620. At 621 it may be determined if any required field is missing, and if so, an alert may be sent to a user at 517 and the import may be stopped at 516. If no required field is missing, then the process may continue to the transforming aspect of the present invention.

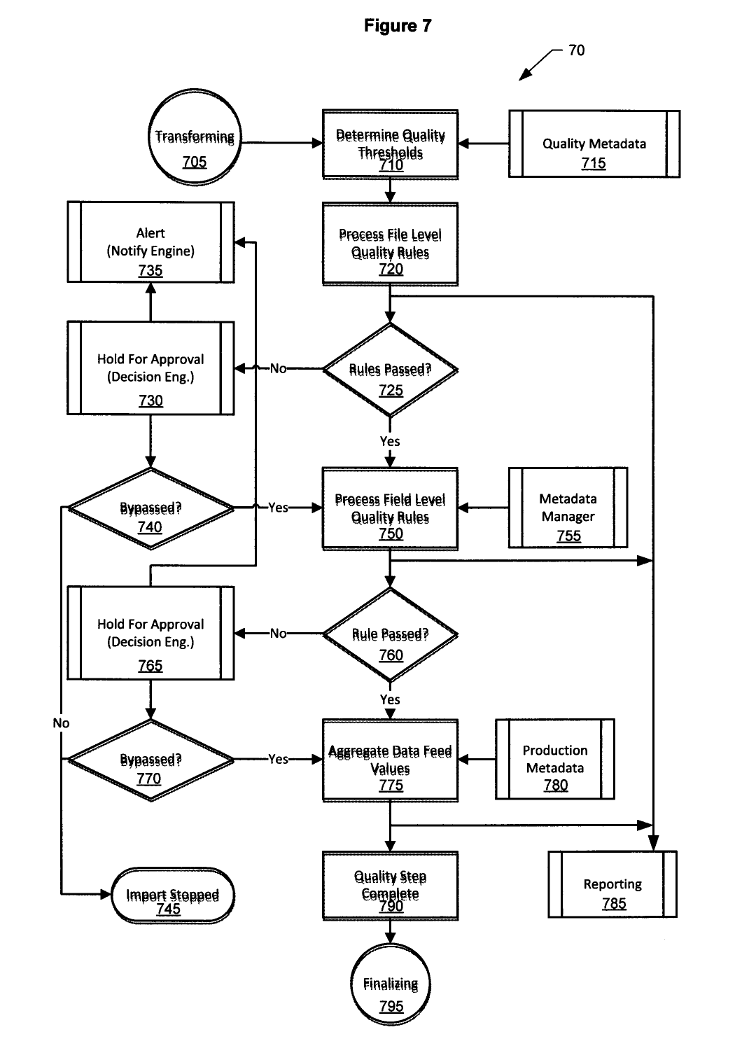

With reference to FIG. 7, an exemplary process of determining data quality, in accordance with some embodiments of the present invention will now be discussed. At 705 data streams may be received from previous transforming processes, and at 710 the quality thresholds may be determined, based at least in part on quality metadata 715. At 720 file level quality rules may be processed, and an initial reporting at 780 may be provided to a user. At 725 it may be determined if the file level quality rules were passed. If not, processing may be held for approval at 730, and an alert may be sent to a user at 735. Approval may also be bypassed at 740. If the approval is not bypassed then the import may be stopped at 745.

If the approval is bypassed, or if the file level quality rules were passed, then the field level quality rules may be processed at 750, which may utilize the metadata manager 755 to provide metadata inputs. It may then be determined if the field level quality rules are passed at 760. If not, the process may be held for approval at 765, and an alert may be sent to a user at 735. The process hold may be bypassed at 765. If the process is not bypassed at 765 then the import may be stopped at 745.

If the process is not bypassed, or if the field level rules are passed, then the data field values may be aggregated at 770, which may include as an input production metadata 775. The quality step may then be deemed complete at 785, and the process may be finalized at 790. Note that reporting 780 may occur at various points in the process, including but not limited to after the processing of file level quality rules (720), after the processing of field level quality rules (750), and after the data feed values are aggregated (770).

With reference to FIG. 8, an exemplary system 80 for determining optimal or near optimal processing paths, in accordance with some embodiments of the present invention will now be discussed. In general, the system 80 may provide parallel processing engines that may determine advantageous server configuration and report on expected throughput before installation. System 80 may generally comprise a node controller 810, a processing engine 820, an analytics engine 830, and a data warehouse 840. Node controller 810 may comprise an element 811 for determining which nodes are best for processing a specified data feed. Processing engine 820 may comprise a plurality of nodes, which may be used for high performance, normal performance, or low performance. A first node 821 may be used for high performance processing. A second, third, and fourth node (822, 823, 824) may be used for normal performance processing. A fifth node 825 may be used for low performance processing. The processing engine 820 may provide inputs to the analytics engine 830 and the data warehouse 840. The analytics engine 830 may comprise elements 831 such as, but not limited to Netezza (which may provide analytics for uses including, but not limited to enterprise data warehousing, business intelligence, predictive analytics, and/or business continuity planning), SAS (statistical analysis system, which may be used to mine, alter, manage and retrieve data from a variety of sources and perform statistical analysis thereon), or any other entity or program that may perform desired analytics.

Data warehouse 840 may comprise a data store 841 that may house historical storage of the data streams, which may be used for various uses (e.g., determining incoming data health, etc.).

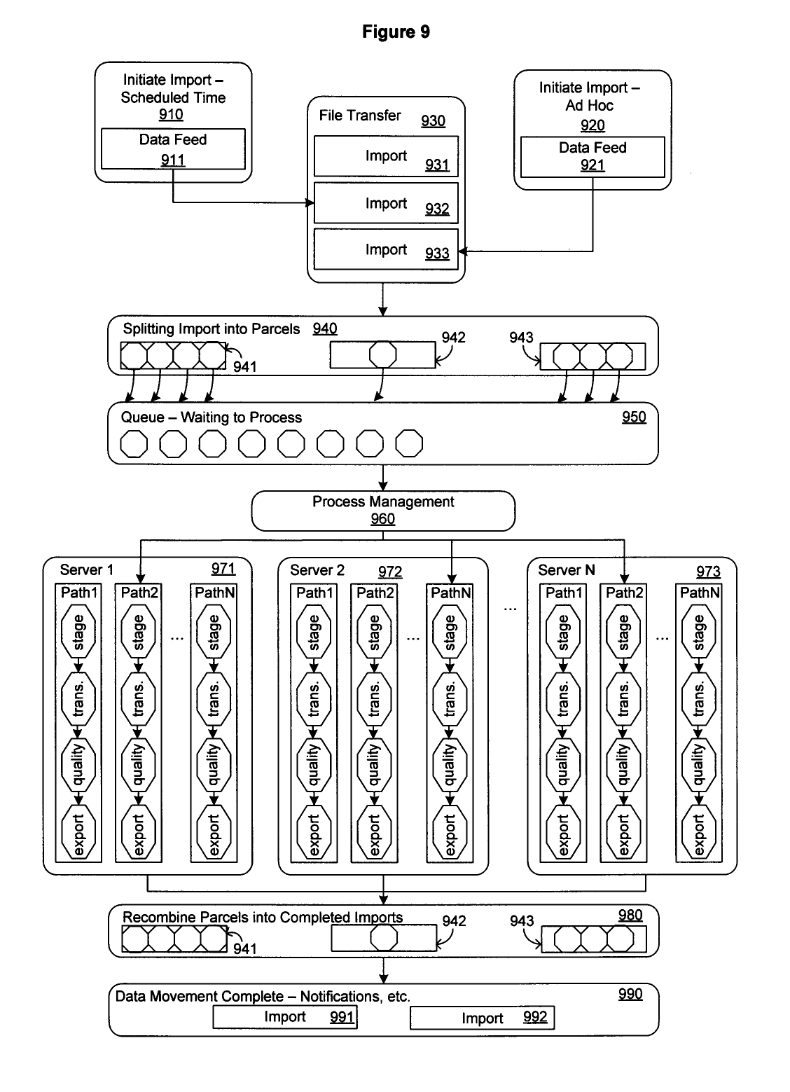

With reference to FIG. 9, exemplary data processing in parallel, in accordance with some embodiments of the present invention will now be discussed. At 910 the importation of a data feed 911 may be scheduled. At 920 an ad hoc import of a data feed 921 may also be initiated. Such data feed imports may be received at file transfer 930, which may receive multiple imports 931, 932, 933. Data feed imports may be split into parcels at 940. For example, as shown first data import may comprise four parcels 941, the second import may comprise one parcel 942, and the third import may comprise three parcels 943. At 950 the parcels may be queued to await processing. At 960 process management may split the parcels amongst a plurality of servers 971, 972, 973. Each server may have various paths of staging, transform, quality, and export (as discussed above).

Once processed through the servers, the parcels may be recombined at 980 into the original imports of four, one, and three parcels respectively 981, 982, 983. At 990 the data movement may be complete, notifications may be provided, and the imports 991, 992 may be reconfigured.

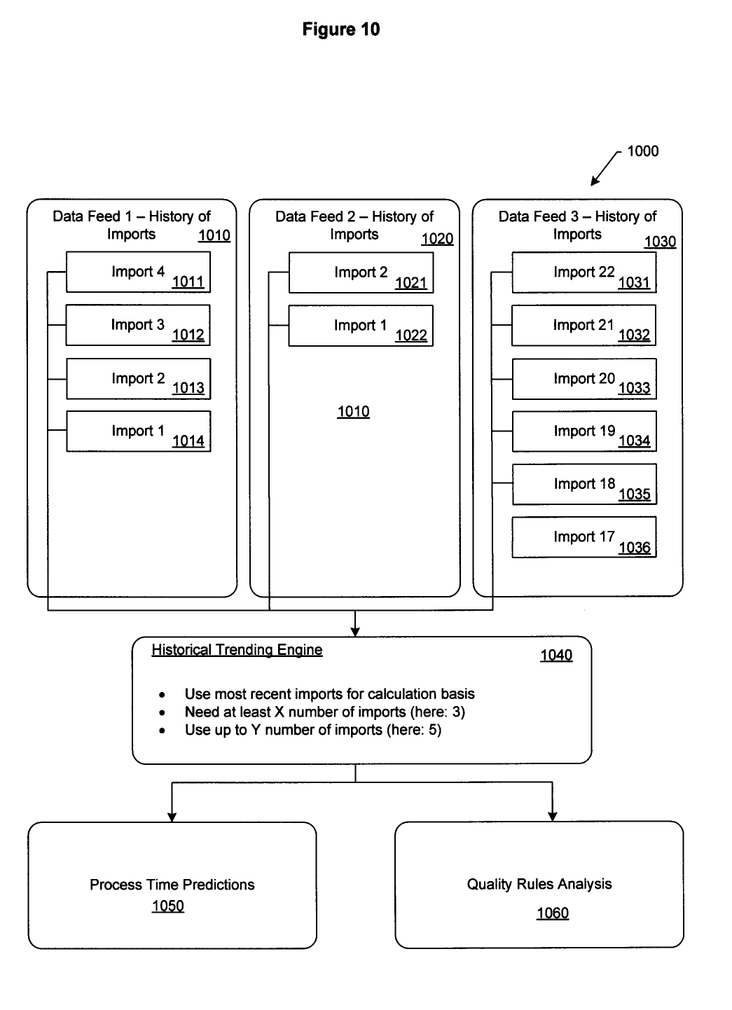

With reference to FIG. 10, an exemplary process 1000 of determining historical trending in a data stream, in accordance with some embodiments of the present invention will now be discussed. Historical trending may be based upon a variety of data feeds. Data feed One 1010 may comprise history related to four (4) data imports 1011, 1012, 1013, 1014. Data feed two 1020 may comprise history related to two (2) imports 1021, 1022. Data feed three may comprise history related to twenty-two (22) imports. It may be first be determined if there is a sufficient history to support trending. For example, data feed two may not have sufficient historical information to support any trending. Data feed one and data feed three may have sufficient information, and may be supplied to historical trending engine 1040.

Historical trending engine 1040 may use the most recent imports for calculation basis (rather than base any trending on outdated information). The historical trending engine 1040 may require a minimum number of imports (as shown, three (3)), and may only utilize a certain amount of the most recent imports (as shown, five (5)). The historical trending engine 1040 may then process time predictions 1050 regarding predicted time for processing, and a quality rules analysis 1060.

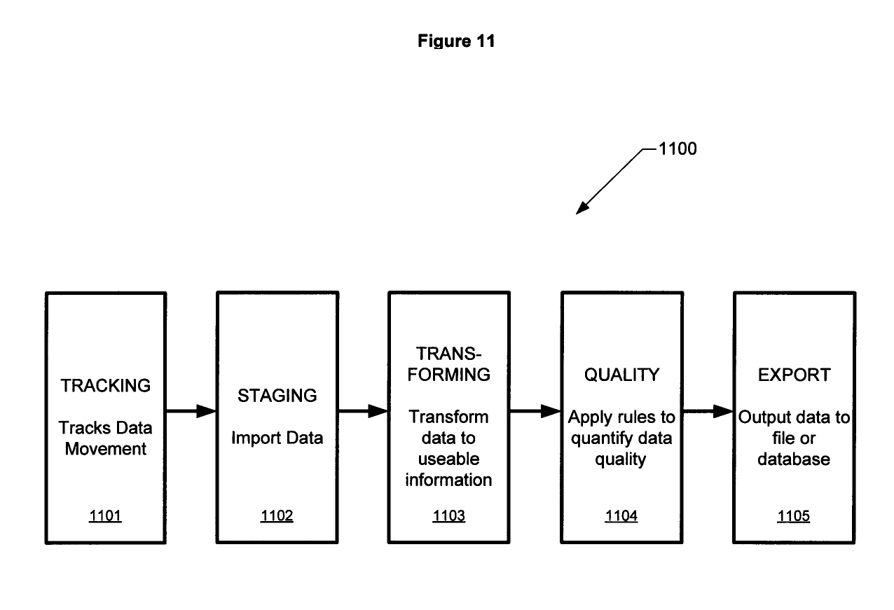

With reference to FIG. 11, a general data flow 1110 much like that in FIG. 1 is set forth. Systems and methods of the present invention may process data through a variety of nodes, comprising: a tracking node 1101 that may track data movement; a staging node 1102 that may import data into the system; a transforming node 1103 that may transform data into useable information; a quality node 1104 that may apply rules to quantify data quality; and/or an exporting node 1105 that may output data to a file, database, or other data store. This information is provided again to orient the reader with regard to the graphic user interface displays presented in FIGS. 12-16.

With reference to FIG. 12, a graphic user interface display 1200 is illustrated that may set forth information related to the tracking component of the system. Display 1200 may include information such as the user who is being displayed the information 1201, tasks currently processing 1202, service level agreement summary 1203, remaining time of imports 1204, elements processed in a given time period 1205, and/or a graphical presentation of standard processing status 1206.

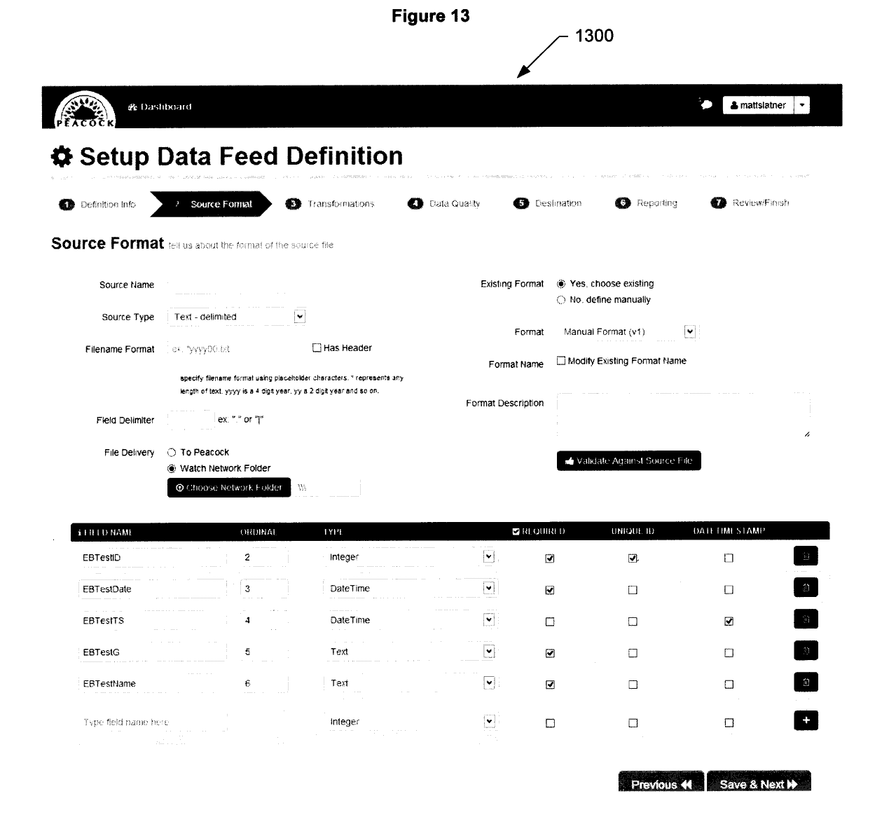

FIG. 13 illustrates an exemplary graphical user interface display 1300 related to the staging component of the system. This may include information such as the source name, format, delivery, field names, etc.

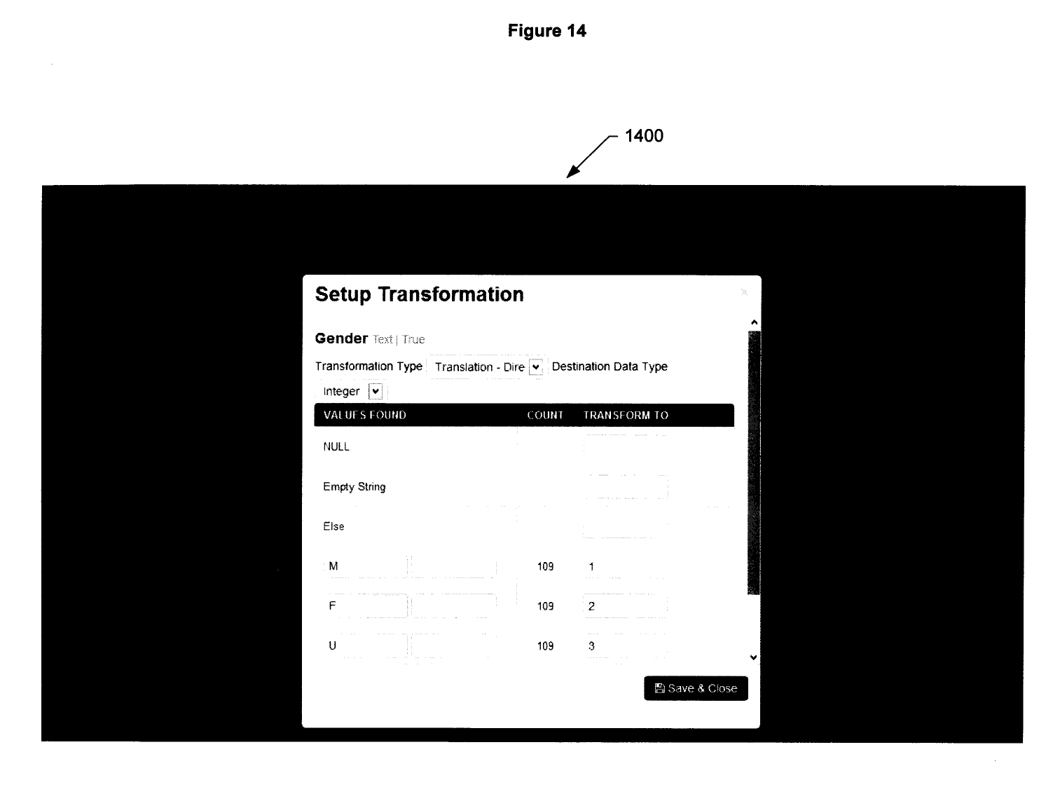

FIG. 14 illustrates an exemplary graphical user interface display 1400 related to the transforming component of the system. This may include information such as the setup transformation data, including values found, etc.

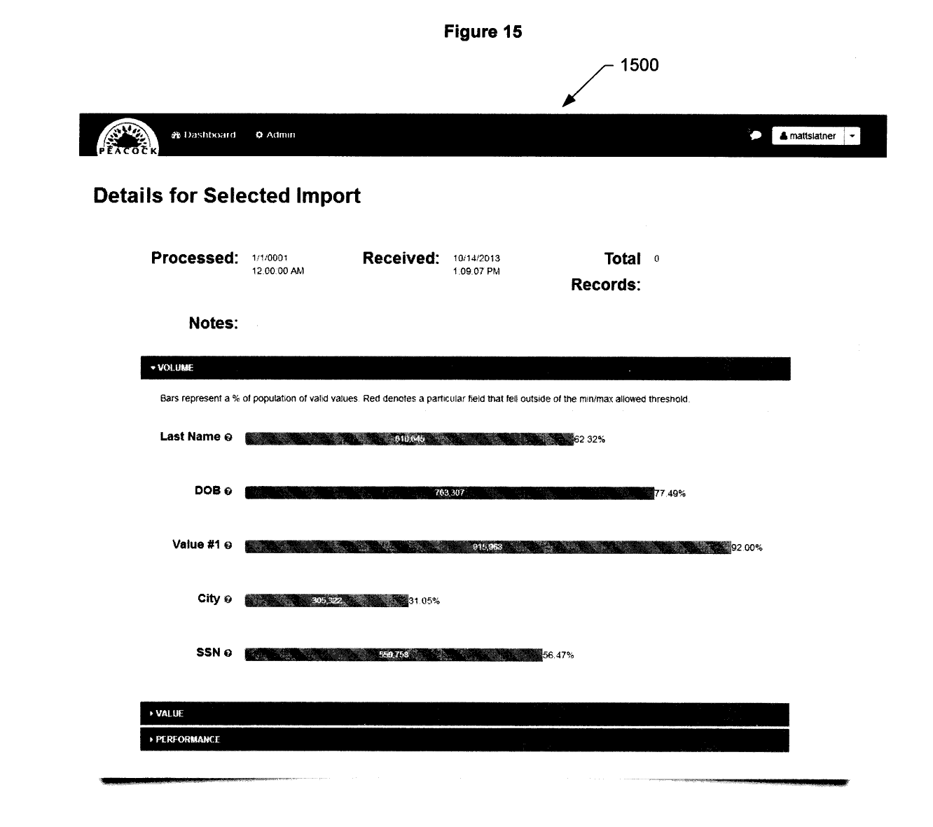

FIG. 15 illustrates an exemplary graphical user interface display 1500 related to the quality component of the system. This may include information such as details for selected import including, but not limited to, the amount processed, received, notes, volume, value, performance, etc. of the system.

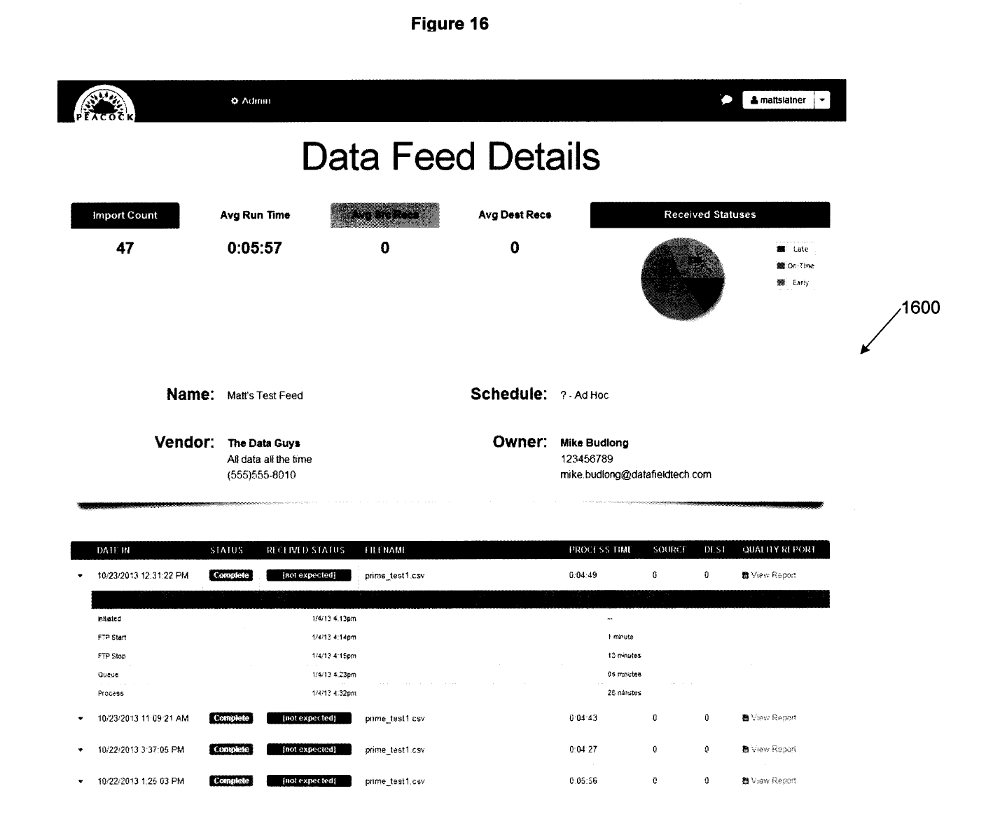

FIG. 16 illustrates an exemplary graphical user interface display 1600 related to the data feed details. This may include information such as import count, average run time, received status, schedules, owners, vendors, etc.

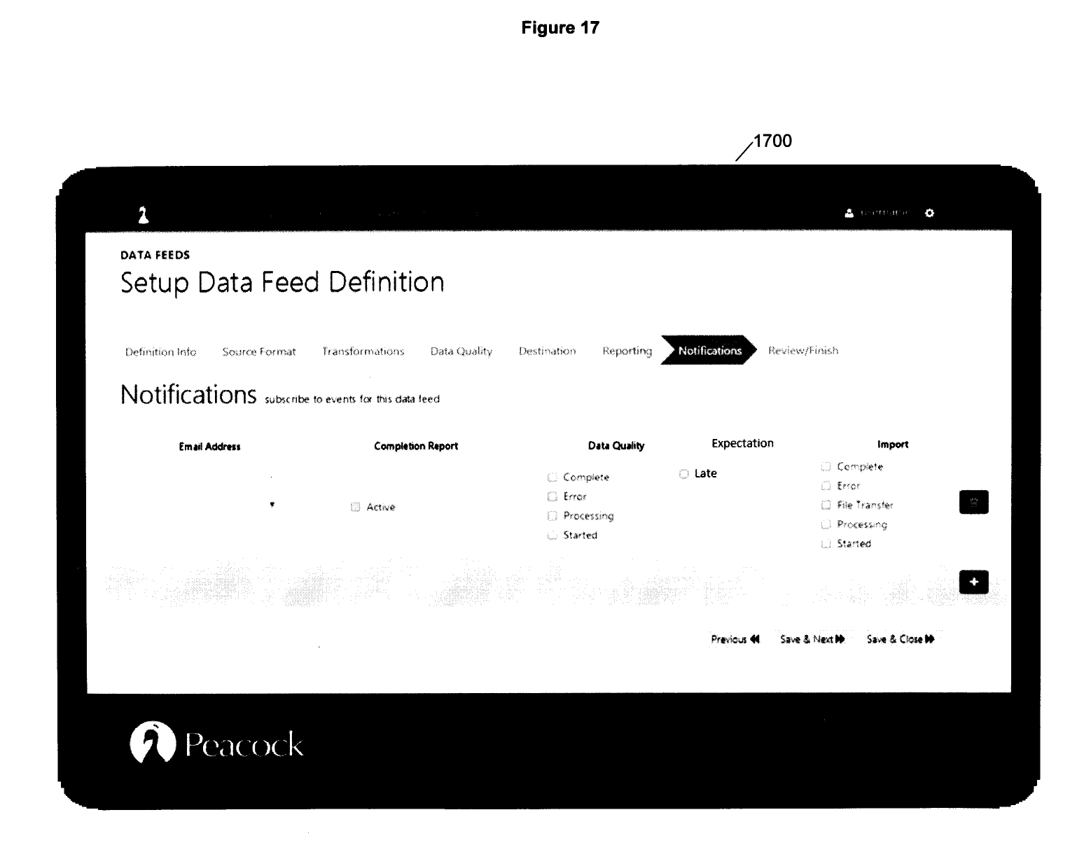

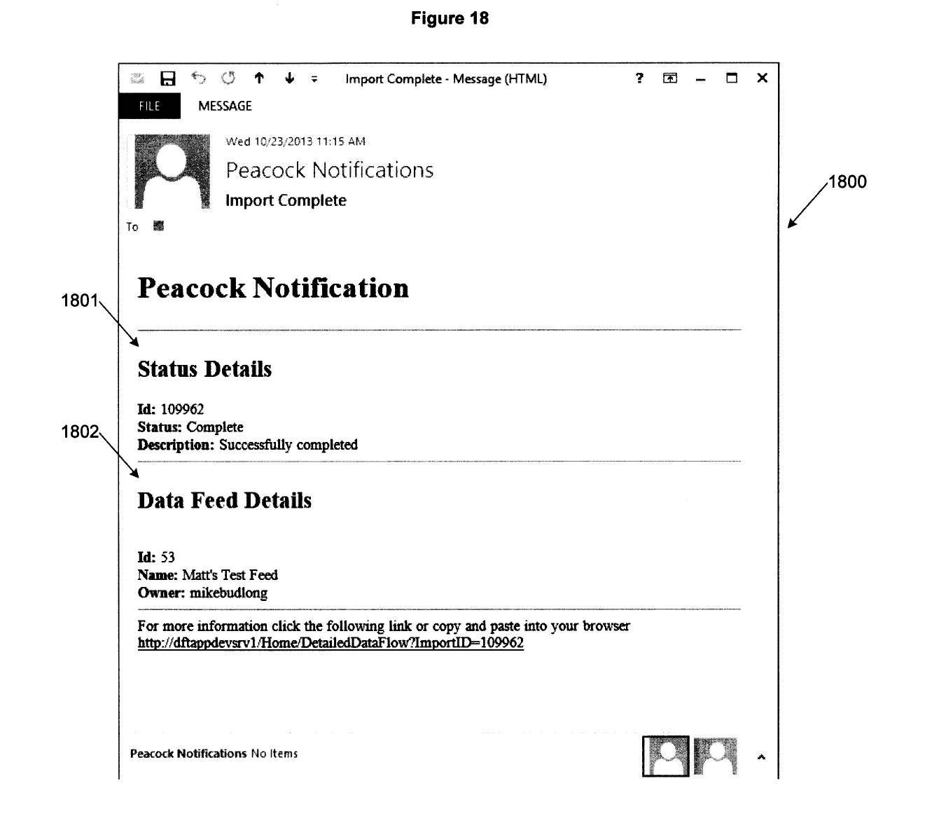

FIG. 17 illustrates an exemplary graphical user interface display 1700 related to the customizable user alerts and notifications. This may include information such as how alerts are to be received, what events should trigger alerts, etc. FIG. 18 illustrates an exemplary alert email 1900, which sets forth status details 1801 of a task and data feed details 1802.

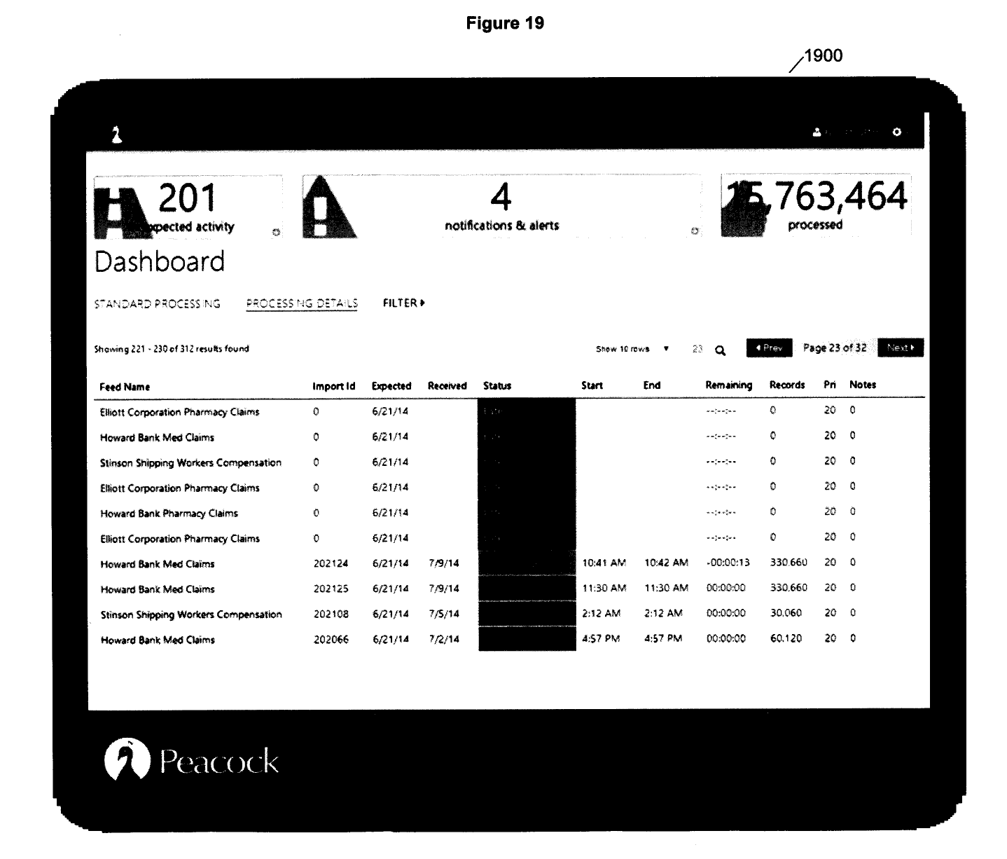

FIG. 19 illustrates an exemplary graphical user interface display 1900 related to the processing details as may be presented from a user dashboard. This may include information such as feed names, import ID, expected times, received, status, start times, end times, remaining time, records, etc.

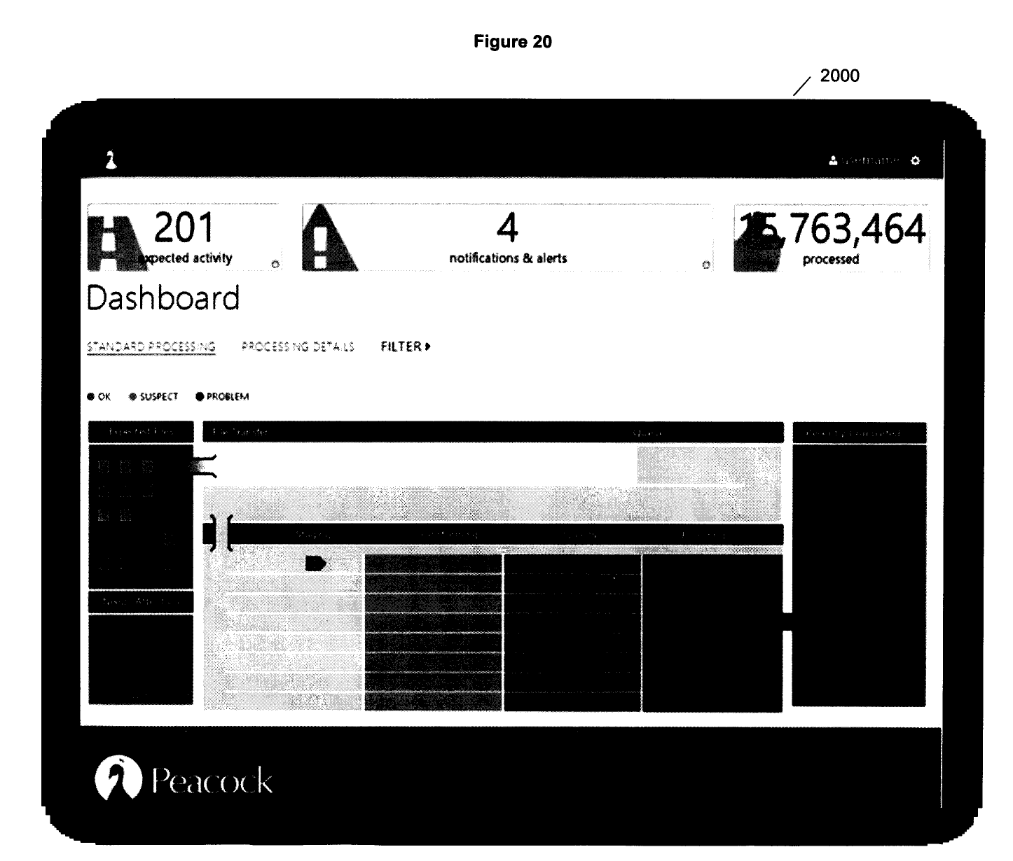

FIG. 20 illustrates an exemplary graphical user interface display 2000 related to the data processing details. This may include graphical information showing the flow of data through staging, transforming, quality, and finalizing processes.

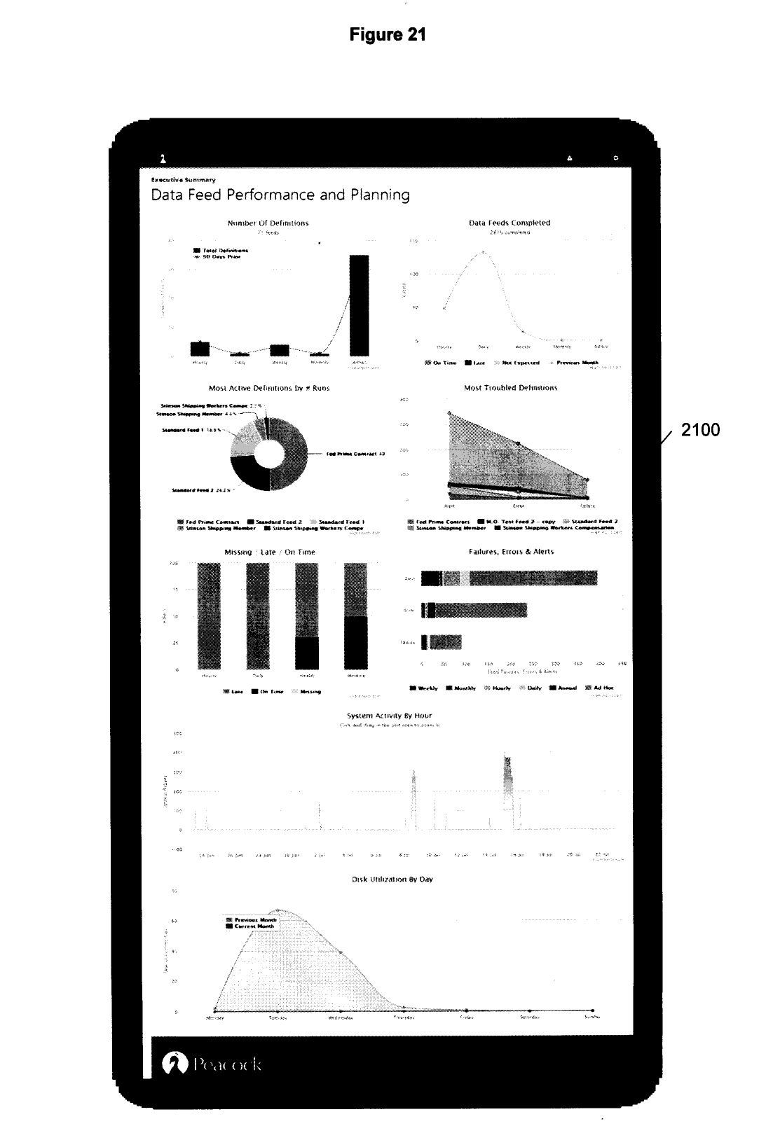

FIG. 21 illustrates an exemplary graphical user interface display 2100 related to the data feed performance and planning. This may include graphical information related to performance presented in various types of charts and graphs.

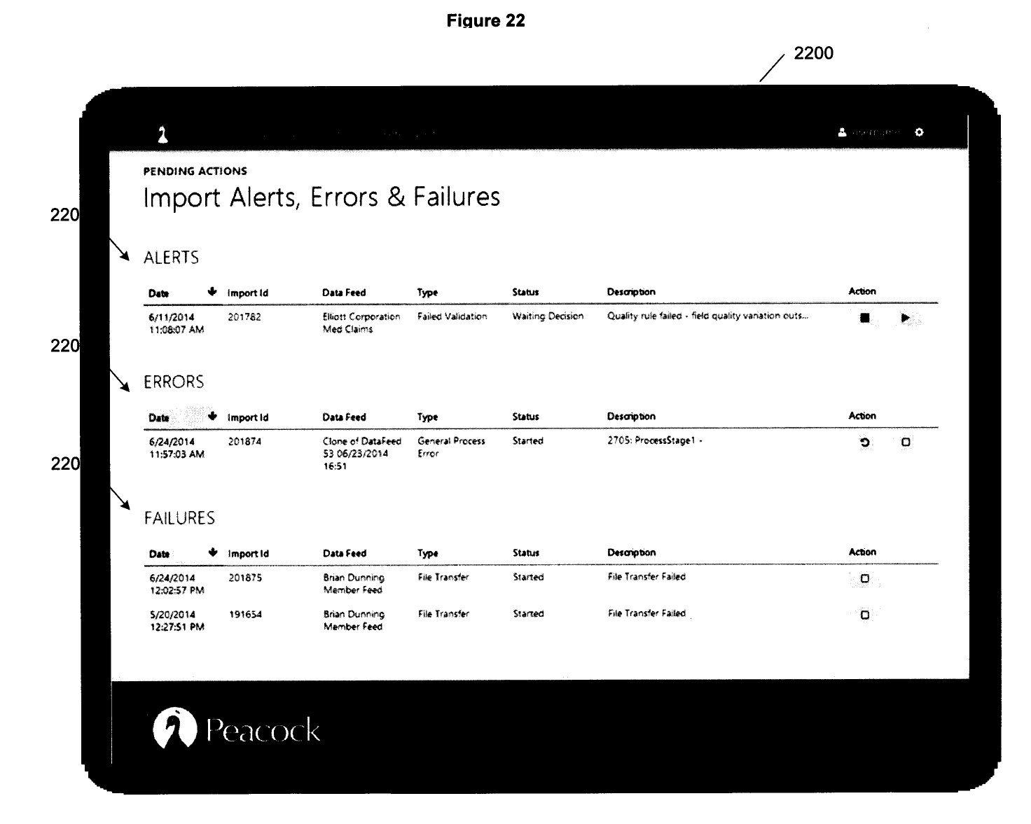

FIG. 22 illustrates an exemplary graphical user interface display 2200 related to the alerts 2201, errors 2202, and failures 2203. This may include related to specific alerts, errors, ad failures, including the date, import ID, data feed, type, status, description, and any required actions.

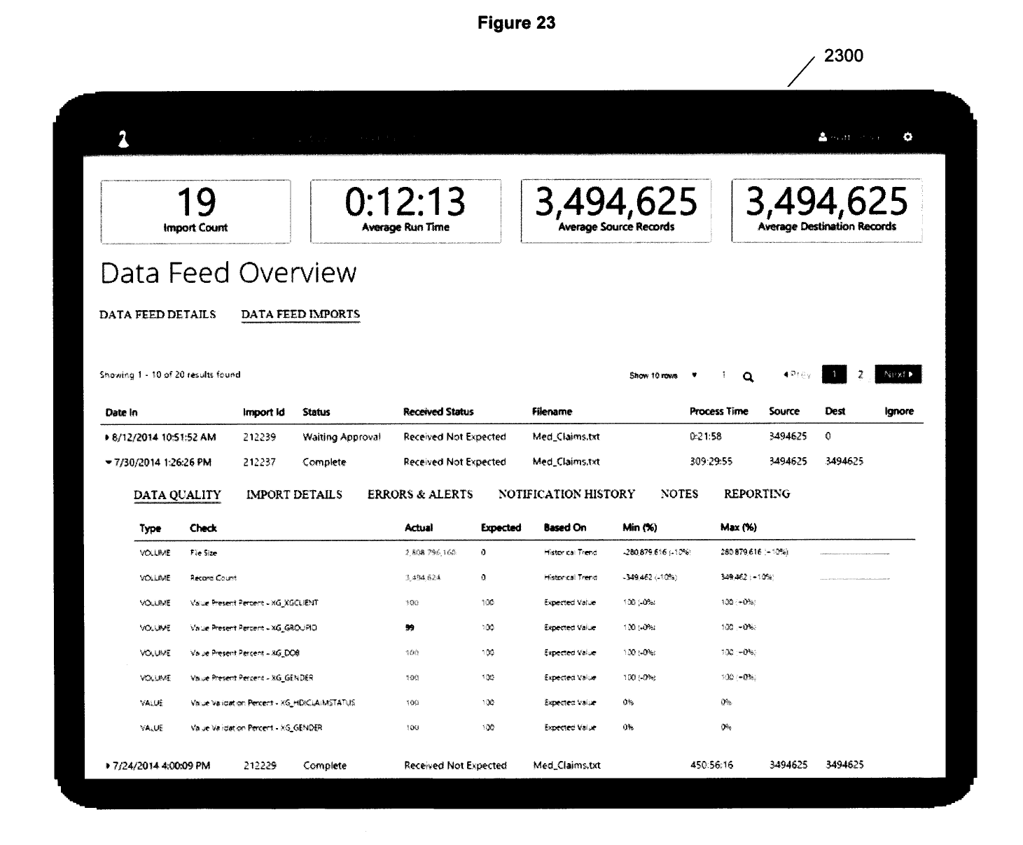

FIG. 23 illustrates an exemplary graphical user interface display 2300 related to the historical data feed logging, and presenting quality metrics for each feed.

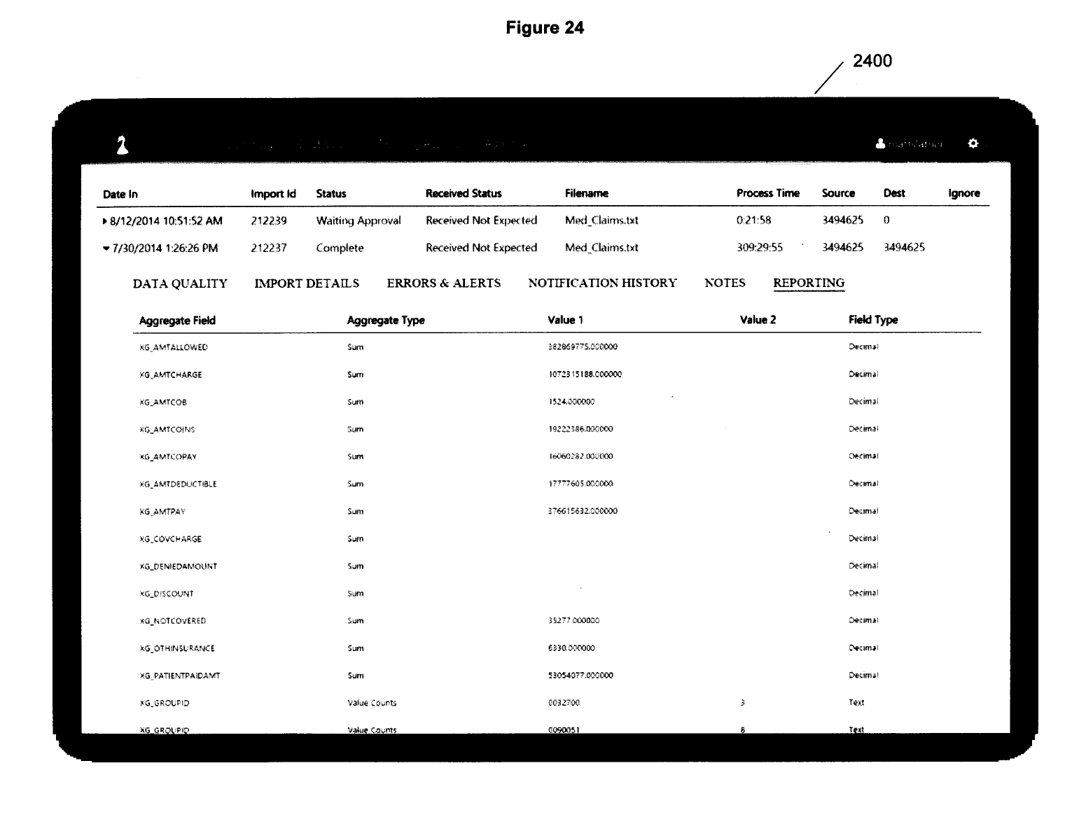

FIG. 24 illustrates an exemplary graphical user interface display 2400 related to service level agreement status information, including information such as aggregate field, aggregate type, values, and field type.

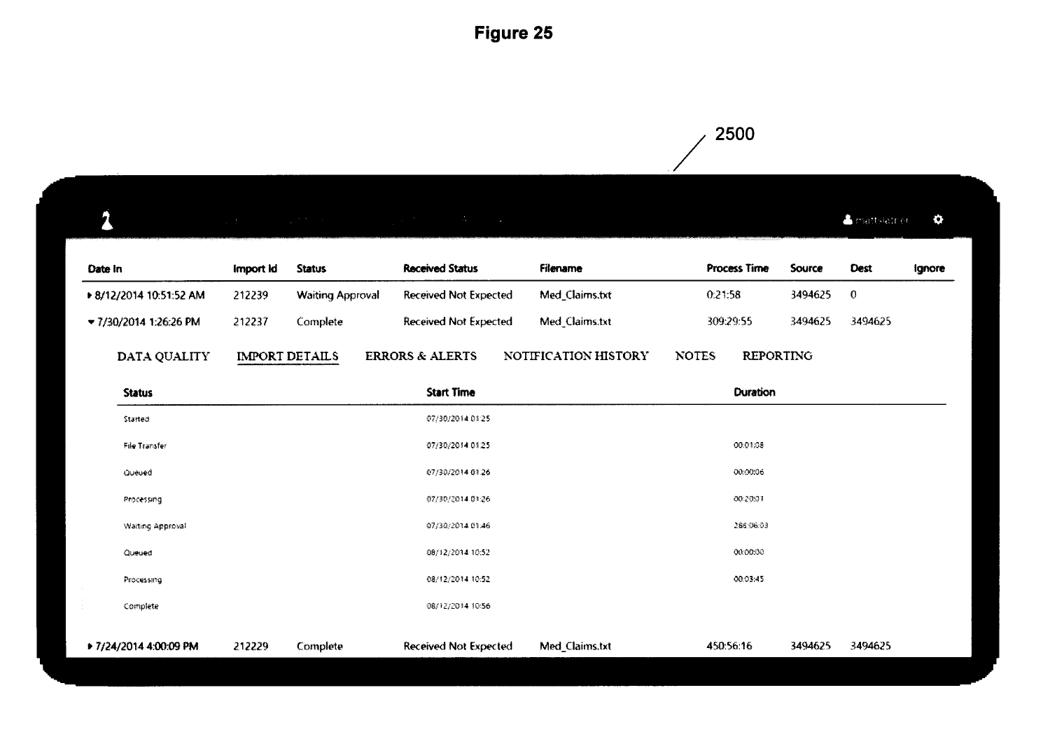

FIG. 25 illustrates an exemplary graphical user interface display 2500 related to auditing of the process, including broad information regarding each import and task.

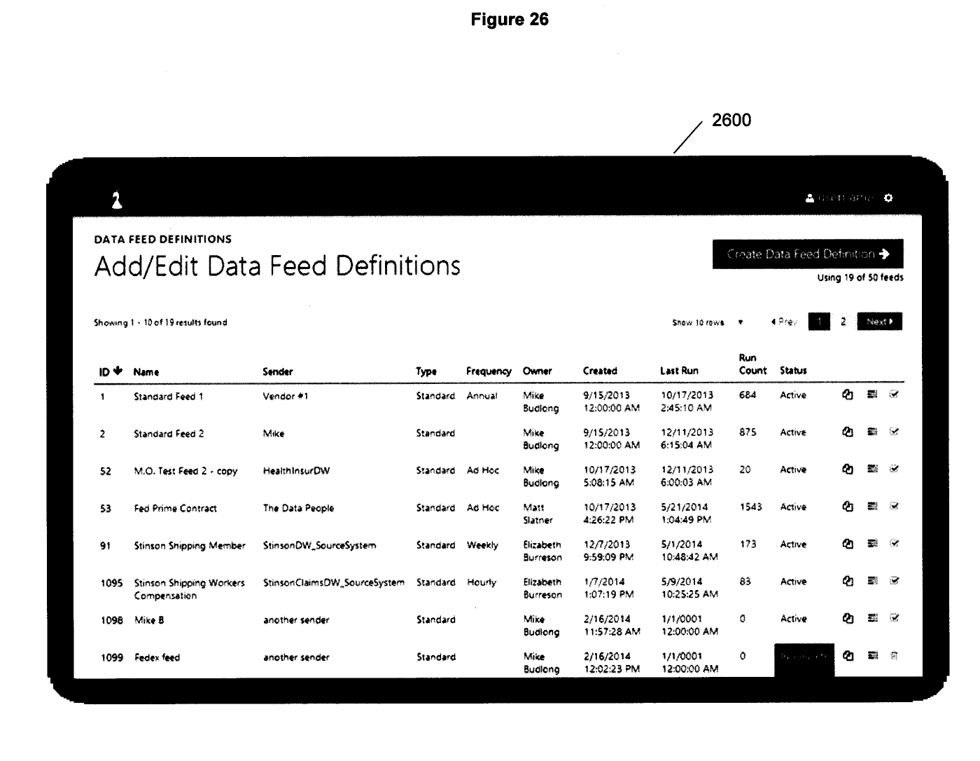

FIG. 26 illustrates an exemplary graphical user interface display 2600 related to add/edit data feed definitions. This may include information such as name, sender, type, frequency, owner, date created, last run, run count, status, etc.

It will be understood that the specific embodiments of the present invention shown and described herein are exemplary only. Numerous variations, changes, substitutions and equivalents will now occur to those skilled in the art without departing from the spirit and scope of the invention. Similarly, the specific shapes shown in the appended figures and discussed above may be varied without deviating from the functionality claimed in the present invention. Accordingly, it is intended that all subject matter described herein and shown in the accompanying drawings be regarded as illustrative only, and not in a limiting sense, and that the scope of the invention will be solely determined by the appended claims.

What is claimed is:

1. A system for providing data managers with a data integration, quality, and management solution that provides visibility of data streams and data quality, provides ability to manage data processing tasks, and determines if a data feed has adequate health to be delivered to an end user or location, the system comprising:
a data processing engine, configured to process a data feed using parallel processing to perform a task, the task selected from the group consisting of: decrypt, stage, transform, validate, filter, encrypt, and archive data feed;
an operations management node in communication with the data processing engine, configured to create metadata for data feeds, the metadata comprising information associated with one or more of: schedule, owner, source information, transformations, quality rules, notifications, reporting, and destination information;
a quality and validation node in communication with the operations management node, configure to quantify quality characteristics of a data stream by utilizing predefined data quality measures and applying historic metadata and historical trends against data feed information;
a decision engine, configured to automatically determine if a data feed requires manual intervention and automatically determine, based at least in part upon metadata, processing paths to be utilized by the data processing engine; and
a graphical user interface that displays on a computer screen data regarding the processing of the data feed, enabling users to control data feed decisions, as alerted by the decision engine, and displaying including real-time operational data, historical data, and metadata associated with the data feed and the data processing task.

2. The system of claim 1, further comprising a metadata repository, comprising a data store that stores metadata associated with the data feed and utilized in transformation, quality, and validation processing tasks of the data feed, the metadata repository in selective communication with the operations management module.

3. The system of claim 1, further comprising a data feed profiling node, configured to analyze data files to automatically determine and file formats of data feeds.

4. The system of claim 1, wherein the graphical user interface is displayed on a computer screen for receiving user selection of data processing options and for presenting to the user analytics regarding the data processing, the user interface comprising a plurality of graphical interface pages arranged in a hierarchical format.

5. The system of claim 4, wherein the plurality of graphical pages comprise a dashboard, which includes links to child pages, the child pages presenting information related to set up of inbound data feeds, destination of inbound data feeds, data feed details, notification or alert settings, status of service level agreement (SLA) conditions or expectations, performance analytics, and reports on data processing tasks.

6. A method of providing visibility of data feed and data quality and determining if a data feed has adequate health to be delivered to an end user or location, the method comprising:
receiving an inbound data feed;
querying a data store to determine if any historical information related to the inbound data feed exists or is applicable;
determining quality rules applicable to the inbound data feed;
determining metadata associated with the data feed;
based upon the historical information, quality rules, and metadata, determining if the data feed has adequate health; and
if it is determined that the data feed has adequate health, processing the data feed; or if it is determined that the data feed does not have adequate health, stopping the import of the data feed and sending an electronic alert to a user.

7. The method of claim 6, wherein the historical information is applicable if the historical information comprises information from a number of events above a predetermined threshold of events.

8. The method of claim 6, wherein the historical information is applicable if the historical information is associated with the inbound data feed and is associated with previous inbound data feeds in a predetermined period of time.

9. The method of claim 6, wherein the step of determining if the data feed has adequate health comprises quantifying the health of the data feed.

10. The method of claim 9, wherein the step of determining if the data feed has adequate health comprises comparing the quantified health of the data feed to a predetermined health threshold value.

11. The method of claim 6, wherein the step of determining if the data feed has adequate health comprises determining if the data feed health satisfies requirements in any applicable service level agreement (SLA).

12. The method of claim 6, wherein the metadata associated with the data feed may comprise information associated with the data feed's source, inventory, expected schedule, data owner, format, transformations, quality rules, notifications, destination information and/or destination format.

13. The method of claim 6, wherein the historical data comprises information related to previous processing tasks and what feeds ran, when previous feeds ran, file size, record counts, percentage of populations, distinct field level values, and/or minimum, maximum, and/or average field level values.

14. A graphical user interface displayed on a computer screen for receiving user selection of data processing options, and for presenting to the user various data and analytics regarding data processing, the user interface comprising:
a plurality of graphical interface pages arranged in a hierarchical format, wherein a dashboard presenting a user with information regarding current processing tasks is a parent page; and
wherein the dashboard comprises links to child pages, the child pages presenting information related to set up of inbound data feeds, destination of inbound data feeds, data feed details, notification or alert settings, status of service level agreement (SLA) conditions or expectations, performance analytics, and reports on data processing tasks.

15. A system for providing visibility of data streams and data quality, an ability to manage data processing tasks, and determining if a data feed has adequate health to be delivered to an end user or location, the system comprising:
a central processor in selective communication with a data processing engine, an operations management module, a quality and validation module, a graphical user interface, and a decision engine, the central processor receiving raw data from the data processing engine and distributing the raw data to, and receiving feed instance data from, the operations management module and quality and validation module;
the data processing engine, configured to receive an inbound data feed from a source and to electronically transmit an outbound data feed to a destination;
the operations management module in selective communication with a data store comprising feed metadata and historical operations metadata;
the quality and validation module comprising one or more data stores comprising historical feed content metadata and feed level thresholds metadata;
the graphical user interface, being displayed on a computer screen for receiving user selection of data processing options, and for presenting to the user various data and analytics regarding data processing, comprising a plurality of graphical interface pages arranged in a hierarchical format; and
a decision engine, configured to determine if the data has a sufficient health to be provided to the outbound destination, and to determine if the outbound data meets any applicable service level agreement requirements.

16. The system of claim 15, wherein the data processing engine is configured to perform processing tasks selected from the group consisting of: decryption, staging, transforming, validation, filtering, encryption, and archiving.

17. The system of claim 15, wherein the feed metadata is selected from the list comprising: expected schedule, business owner, source contact information, source format, transformations, data quality rules, notifications, destination information, and destination format.

18. The system of claim 15, wherein the historical feed content metadata includes information related to file size, record counts, and field level values; and wherein the feed level thresholds metadata comprises information regarding expected values related to file size, record counts, and field level values.

19. The system of claim 15, wherein the graphical user interface provides raw data configuration information to the central processor.

20. The system of claim 15, wherein the operations management module, the quality and validation module, and the decision engine provide decision engine data to the central processor.
